(19) United States
(12) Patent Application Publication
(10) Pub. No.: US 2003/0212878 A1
(43) Pub. Date: Nov. 13, 2003

(54) Scaleable microprocessor architecture

(76) Inventor: Chen-Hanson Ting, San Mateo, CA (US)

Correspondence Address: Chen-Hanson Ting, 156 14th Avenue, San Mateo, CA, 94402-2427, US

(21) Appl. No.: 10/139,537

(22) Filed: May 7, 2002

(51) Int. Cl. G06F 9/30

(52) U.S. Cl. 712/23; 712/202

(57) ABSTRACT

A scaleable microprocessor architecture has an efficient and orthogonal instruction set of 20 basic instructions, and a scaleable program word size from 15 bits up, including but not limited to 16, 24, 32, and 64 bits. As many instructions are packed into a single program word as allowed by the size of a program word. An integral return stack is used for nested subroutine calls and returns. An integral data stack is also used to pass parameters among nested subroutines. The simplified instruction set and the dual stack architecture make it possible to execute all instructions in a single clock cycle from a single phase master clock. Additional instructions can be added to facilitate accessing arrays in memory, for multiplication and division of integers, for real time interrupts, and to support an UART I/O device. This scaleable microprocessor architecture greatly increases code density and processing speed while decreasing significantly silicon area and power consumption. It is most suitable to serve as microprocessor cores in System-on-a-Chip (SOC) integrated circuits.

### BACKGROUND

1. Field of the Invention

The present invention relates generally to a microprocessor architecture which has a simple, efficient, and orthogonal instruction set and can be implemented in program word sizes ranging from 15 bits up to 64 bits, and such scaleable microprocessors are most suitable to be used as cores of System-on-a-Chip (SOC) integrated circuits.

2. Description of the Prior Art

Currently the prevailing computer and microprocessor architectures are all register-centric, in that the central processing unit CPU in a microprocessor contains a large set of registers. Data from memory and I/O devices are first read into the registers to be processed by the CPU. Results are then written out from the registers to memory or to I/O devices. Complicated Instruction Set Computers (CISC) like Intel 80×86 and Motorola 680×0 have instructions which can read data from memory, using many different memory accessing modes, and also operate on the data in the same instruction. The instruction set becomes complicated by large number of different memory accessing modes. The Reduced Instruction Set Computers (RISC) like SPARC from Sun Microsystems, MIPS from MIPS Technology, and PowerPC from IBM simplify the instruction set by segregating the memory accessing instructions from the data processing instructions. The instruction set is simplified because only memory accessing instructions can read from or write to memory. Data processing instructions only process data already fetched into registers. Although data processing instructions in RISC computers avoid complexity of memory addressing modes, they still have to specify operands in source and destination registers, in addition to operations to be performed on the operands.

The prior art of prevailing computer architecture was best summarized in John Hennessy and David Patterson's classic textbook, Computer Architecture: A Quantitative Approach, (1996). In spite of their arguments in favor of the RISC architecture, the CISC architecture continually developed and improved by Intel Corp. had dominated the desk top personal computers, and recently began to intrude into workstations where RISC computers like SPARC and PowerPC controlled a major share.

In the mean time, families of RISC computers had also evolved with many added functions and circuitry, to the point that newer RISC computers are as complicated as the newer CISC computers. The only characteristic distinguishing RISC computers from CISC computers is that instructions in RISC computers are encoded in 32-bit format.

In either CISC or RISC architecture, there are at least 4 phases in executing an instruction. An instruction is first fetched from memory, source operands must be identified and routed to arithmetic logic unit ALU, ALU performs operations on the operands, and finally results are written back to a destination register. Enormous efforts have been spent in CPU designs to accelerate these phases to make CPU run faster, using techniques like program and data caches, program execution pipelines, and superscalar designs with parallel processing units.

In contrast, stack-based CPU architecture does not require decoding of operands in source and destination registers, because source operands are taken from the top of a data stack, and results are placed back on the top of the same stack. Thus stack computers are much simpler and can run much faster than register computers, especially when data stack is implemented in CPU on a single silicon die.

Advantages of stack-based CPU architecture were clearly stated in Philip J. Koopman's Stack Computers-The New Wave (1989). Since then, there were many patents granted to stack-based computer designs, exemplified by the following four patent groups: U.S. Pat. Nos. 4,980,821(1990) and 5,053,952 (1991) to Koopman et al. on 16- and 32-bit micro-coded stack microprocessor, U.S. Pat. Nos. 5,070,451 (1991) and 5,319,757 (1994) to Moore et al. on 16-bit horizontally coded stack microprocessor, U.S. Pat. No. 5,404,555 (1995) to Liu on a very long instruction set stack microprocessor, and U.S. Pat. Nos 5,440,749 (1995), 5,530,890 (1996), 5,659,703 (1997), 5,784,584 (1998), 5,809,336 (1998) to Moore et al. on a 32-bit byte code stack microprocessor. These designs clearly demonstrated that when two stacks were incorporated into the CPU, microprocessor architecture was greatly simplified and high performance microprocessors could be constructed with much fewer gates and logic circuitry.

The stack-based computers described above were designed to execute the high level programming language FORTH. Since FORTH generally consists of a large set of commands, earlier stack-based computers attempted to include as many FORTH commands as machine instructions. However, the latest designs by Moore (1995-1998) limited the machine instructions to a set of about 200 instructions, and encoded these instructions in 8-bit byte code. This instruction set was still fairly complicated like the CISC computers and required very substantial amount of logic to implement.

Architects of SPARC from Sun Microsystems recognized the importance of parameter passing among nested subroutines, and responded with a design of stack frames using overlapped register windows. A stack frame contains 24 registers, with 8 top registers, 8 local registers and 8 bottom registers. When a subroutine is called, the register window slides up on the stack frame by 16 registers, so that top registers in a calling program become bottom registers in the called subroutine. On subroutine return, the register window slides down by 16 registers, and the calling program can read returned values from subroutine's bottom registers in its own top registers. This stack frame uses the same principle of a data stack, but is very inefficient in the use of registers because most subroutines do not need 24 registers for parameter passing.

In a stack-based CPU architecture, subroutines themselves decide how to use the data stack, on how many items to be removed from the stack and how many items are pushed back on the stack. It is the most efficient way to use data stack, which is a very important and expensive resource in the CPU. However, it does require that all subroutines access stacks correctly, and impose very strict discipline on the use of stacks.

The most serious deficiency in RISC architecture is very low code density in its 32-bit instruction format. Since each instruction is encoded with all 32 bits in a program word, program size is generally much larger than the equivalent programs compiled on CISC or stack computers. CISC computers like Intel 80×86 have instructions from 8-bits to 40-bits, and code density varies depending on programs. Code density of CISC computers is generally higher than RISC processors but lower than the stack computers.

Recent interests in JAVA language processors, as in U.S. Pat. Nos. 6,317,872 (2001) granted to Gee, 6,324,688 (2001) to Brown, and 6,332,215 (.2001) to Patel, showed that stack architecture was accepted by computer industry for cross-platform execution of programs distributed over Internet. Use of stacks eliminates parameter lists passed among nested subroutines. It greatly simplifies hardware CPU design and software complexities in processing parameter lists. However, the large set of instructions in the form of byte codes, and the weak subroutine calling and returning mechanism in JAVA, still call for more and better architecture improvements.

### SUMMARY OF THE INVENTION

A scaleable microprocessor architecture has an efficient and orthogonal instruction set comprising of 20 basic instructions, and a scaleable program word size ranging from 15 bits up, including bet not limited to 16, 24, 32, and 64 bits. As many instructions are packed into a single program word as allowed by program word size. An integral return stack is used for nested subroutine calls and returns. An integral parameter stack is also used to pass parameters among nested subroutines. The simplified instruction set and the dual stack architecture make it possible to execute all instructions in a single clock cycle from a single phase master clock. The scaleable microprocessor architecture greatly increases code density and processing speed while decreasing significantly silicon area and power consumption. It is most suitable to serve as microprocessor cores in System-on-a-Chip (SOC) integrated circuits. Additional instructions can be added to facilitate accessing arrays in memory, for multiplication and division of integers, for real time interrupts and to support I/O devices like UART.

### OBJECTS AND ADVANTAGES

It is the object of this invention to provide a microprocessor architecture based on a dual stack central processing unit (CPU) with a set of 20 simple, efficient and orthogonal instructions. An orthogonal instruction set contains instructions with minimal redundant and overlapped functions. These instructions can be encoded in 5-bit fields of a program word. Using 5-bit instructions, it is possible to construct microprocessors of word size scaleable from 15 bits up, including but not limited to 16, 24, 32, and 64 bits. Since all these microprocessors execute an identical instruction set, they can share subroutine libraries, software development tools, and operating systems.

It is another object of this invention to provide a series of microprocessors with dual stack CPU and 5-bit instructions, which latch the appropriate data into all the registers and stacks on the rising edge of a master clock. Such synchronous architecture ensures that all instructions are executed quickly and reliably in a single clock cycle from a single phase master clock.

It is a further object of this invention to provide microprocessor systems, comprising a central processing unit using said instruction set, a memory device, and a plurality of I/O devices, in a single integrated circuit. Such microprocessor systems form the cores of System-on-a-Chiip (SOC) integrated circuits.

The attainment of these and related objects may be achieved through use of a novel design herein disclosed. In accordance with one aspect of the invention, a microprocessor system in accordance with this invention has a central processing unit CPU, a means to connect to an external reset signal RST, a means to connect to a master clock signal CLK, a memory device to store program words and data, a means to connect said memory device to said CPU in the form of an address bus, a data bus and a plurality of control signals, and a means to connect to external I/O devices like a terminal. Said address bus and said data bus have the same width N as the word size of the microprocessor, from 15 bits up, including but not limited to 16, 24, 32, and 64 bits. Said plurality of memory bus control signals comprise read-enable signal RE and write-enable signal WE. Said means to connect to external terminal device includes a transmitter output signal TX and a receiver input signal RX. In addition, the CPU accepts a plurality of interrupt signals through a set of interrupt input pins.

In accordance with another aspect of the invention, said central processing unit CPU in accordance with this invention has a plurality of registers and stacks, a plurality of multiplexers, a plurality of logic circuits, means to connect the said multiplexers to said registers and stacks, means to connect said logic circuits to said multplexers, means to connect said registers and stacks to said logic circuits, and means to control the said registers and said multiplexers. On the rising edge of a master clock, new data routed by said multiplexers to said registers and stacks are latched into said registers and stacks, according to the instruction selected from the program word currently being executed. This sequence is repeated on the rising edge of every clock to make said microprocessor system execute a program.

In accordance with another aspect of the invention, said central processing unit CPU in accordance with this invention comprises of a data processing unit, an address processing unit, a program sequencing unit, an address storage unit, and other minor circuits. Said data processing unit comprises of a top data register T, a second data register S, an arithmetic logic unit ALU, and a set of registers organized as a last-in-first-out (LIFO) data stack SSTACK. Said address processing unit comprises of a program address register P, a data address register X, and an address multiplexer AMUX. Said program sequencing unit comprises of an instruction latch register I, an instruction counter register C, and an instruction decoder DECODER which provides all control signals to the registers and multiplexers in said CPU. Said address storage unit comprises of a return address register R, and a set of registers organized as a LIFO return stack RSTACK.

Said T and S registers provide two operands to said ALU, and results from said ALU are sent back to said T register. Contents in said T and S registers can be saved to and restored from said data stack SSTACK. Said P register provides addresses of next program words to said memory device. Said X register provides addresses for reading data from said memory into said T register or writing data to said memory from said T register. Program words are read into said I register. Instructions in said I register are selected by a count in said C register, and are sent to said DECODER to produce control signals. Contents in said P register can be saved and restored from said R register and said return stack RSTACK.

In accordance with another aspect of the invention, said central processing unit CPU is controlled by two external control signals, a reset RST and a master clock CLK. When said RST is asserted, all internal registers and stacks are released. When said RST is released, first program word is read from memory location 0 and latched into said instruction latch register I on the rising edge of said CLK. Said instruction counter register C is incremented on the rising edges of said CLK, and selects one instruction in said I register to be decoded. Said instruction is decoded in said DECODER which sends proper control signals to registers and multiplexers in said CPU, routing proper data to all registers and stacks. On the rising edge of said CLK, required results are latched into enabled registers and stacks. When last instruction in a program word is executed, said instruction counter register C is reset to 0, and next program word will be latched into said I register on the rising edge of said CLK.

In accordance with another aspect of the invention, said address multiplexer AMUX is connected to said memory device,. Said AMUX receives either an address from said program address register P to fetch the next program word into said I, or from said data address register X, when said CPU reads from said memory device into said T register or writes data from said T register to said memory device.

In accordance with another aspect of the invention, said CPU also has a bidirectional means connected to said memory device. Said bidirectional means supplies next program word from said memory device to said instruction latch register I. Said bidirectional means also supplies data from said memory device to said T register during a memory read operation. Said bidirectional means also outputs data from said T register to said memory device during a memory write operation. During said program word read operation and said data word read operation, a memory read-enable RE signal is asserted. During said data word write operation, a memory write-enable signal WE is asserted.

In accordance with another aspect of the invention, said CPU has an arithmetic logic unit ALU which takes in a first operand from said T and a second operand from said S registers, and generate a plurality of resulting signals. Said ALU contains circuitry to generate a plurality of signals simultaneously and in parallel comprising of results from an adder which adds said S to said T, results of AND'ing said S to said T, results of exclusive OR'ing said S to said T, one's complement of said T, and arithmetic right shift of said T.

In accordance with another aspect of the invention, said central processing unit CPU has a top data multiplexer TMUX connected to said top data register T,. Said TMUX selects data from said X register, said S register, said R register, said memory device, or an output from said ALU, and routes selected data to said T register. An ALU instruction controls said TMUX to select desired data, and latches selected data into said T register on the rising edge of said CLK. When ALU instruction is an addition, a carry bit from said adder is also latched into a carry register CY; otherwise, said CY register is cleared.

In accordance with another aspect of the invention, when said CPU executes an arithmetic right shift instruction, the least significant bit in said T is latched into a flip-flop UFF, which drives an output signal TX in a transmitter of a serial output device. In the mean time, input signal RX in a receiver of a serial input device is latched into said CY register. Thus connected, said CPU can transmit ASCII code to an external terminal device through said TX and receive ASCII code from said terminal through said RX, all under software control. This very simple mechanism adds a powerful serial I/O device to said CPU for debugging and for user interaction.

In accordance with another aspect of the invention, said CPU has a program address multiplexer PMUX connected to said program address register P,. Said PMUX selects a branch address computed from current contents in said P and said I, a return address from said R register, or the address in said P incremented by 1. There are two different models to compute said branch address. In a branch instruction, part of the program word is allocated to an address field. In a relative branching model, contents in said address field is sign-extended and added to the current address in said P register to form a branch address. In a page-absolute branching model, contents in said address field of a program word is extracted and replace the same portion of the address in said P register to form a branch address.

In accordance with another aspect of the invention, said CPU has a second data mulitplexer SMUX connected to said second data register S,. Said SMUX selects data from said T register, or from said data stack SSTACK to be latched into said S register. When said S register is setup to save contents from said T register, contents of S register are pushed on said data stack SSTACK. When said S register is to restore said T register, contents in top item on said data stack SSTACK is popped back into said S register. All the saving, restoring, pushing, and popping actions occur on the rising edge of said CLK.

In accordance with another aspect of the invention, said CPU has a return address multiplexer RMUX connected to said return address register R,. Said RMUX selects data from said T register, from said P register or from said return stack RSTACK to be latched into said R register. When said R register is setup to save contents from said T register or from said P register, contents of said R register are pushed on said return stack RSTACK. When contents in said R register are used to restore T register or P register, contents in top item on said return stack RSTACK is popped back into said R register. All the saving, restoring, pushing, and popping actions occur on the rising edge of said CLK.

In accordance with another aspect of the invention, said CPU has two types of instructions: short instructions each occupying a 5 bit field in a program word, and long instructions which contains an address field in addition to the 5-bit instruction field. Width of said address field depends on the width of said program word and on requirements of said microprocessor system. Long instructions are used for branching and subroutine call instructions, and only one long instruction is allowed in a program word. A plurality of short instructions can be packed in front of a long instruction to fill a program word. Here is a minimal and orthogonal set of instructions required for efficient operations of said CPU:

| | |
|---|---|
| BRA aaa | Branch unconditionally to address aaa. |
| BZ aaa | Branch to address aaa if T=0. |
| BC aaa | Branch to address aaa if CY=0. |
| CALL aaa | Branch to address aaa, push R on return stack, and save |
| | P to R. |
| RET | Restore P from R and pop return stack to R. |
| LD | Read memory pointed to by X into T, save T to S, and push S |
| | on data stack. Clear CY. |
| LDI | Read memory pointed to by P into T, save T to S, and push S |
| | on data stack. Increment P. Clear CY. |
| ST | Store T to memory pointed to by X, restore T from S, and pop |
| | data stack to S. |
| ADD | Add S to T and pop data stack to S. Set CY accordingly. |
| AND | AND S to T and pop data stack to S. Clear CY |
| XOR | Exclusive OR S to T and pop data stack to S. Clear CY. |
| COM | One's complement of T. Clear CY. |
| SHR | Arithmetic right shift of T. Clear CY. |
| TA | Copy T to X, copy S to T, and pop data stack to S. |
| TS | Save T to S, and push S on data stack. |
| TR | Pop data stack to S, copy S to T, save T to R, and push R on |
| | return stack. |
| AT | Copy X to T, save T to S, and push S on data stack. |
| ST | Restore S to T and pop data stack to S. |
| RT | Pop return stack to R, copy R to T, save T to S, and push S to |
| | data stack. |
| NOP | No operation. |

Said instruction set is orthogonal because all other CPU functions can be synthesized from them, and none of said instructions can be synthesized from other said instructions. There are only two exceptions: that XOR can be synthesized from AND and COM, and that NOP can be synthesized from COM-COM, TA-AT, TS-ST, and TR-RT pairs. However, XOR and NOP are extremely important logic operations. They are used very often and are thus included in said instruction set.

In accordance with another aspect of the invention, said CPU has a data address multiplexer XMUX connected to said data address X register,. Said XMUX selects data from said T register which normally is the sole source to said X register, or from an address in said X register incremented by 1. When said X register is setup to read data from said memory device into said T register, or to write data from said T register to said memory device, the address in said X register can be incremented by 1, or stay unchanged. Auto-incrementing said X register allow said CPU to read or write a large range of contiguous memory area. With this auto-incrementing mechanism, said CPU needs two additional instructions to read and write memory with auto-incrementing:

| | |
|---|---|
| LDP | Read memory pointed to by X into T, save T to S, and push S on |
| | data stack. Clear CY. Increment X. |
| STP | Store T to memory pointed to by X, restore T from S, and pop data |
| | stack to S. Increment X. |

In accordance with another aspect of the invention, said RMUX in front of said R register may optionally receive an address in said R register decremented by 1. With this new mechanism, said R register can be used as a loop counter to support a new loop instruction LOOP::

LOOP aaa If R=0, pop return stack to R, exit the loop by fetch and execute the next program word. If R is not zero, decrement it and loop back to address aaa.

In accordance with another aspect of the invention, said XMUX in front of said X register may optionally receive data from said X register right shifted by 1 bit. The most significant bit of said XMUX may receive either the least significant bit of said T register, or the least significant bit from said adder which adds S to T. In addition, said TMUX in front of said T register is expanded to receive data from said adder or from T register, right-shifted by 1 bit. With these mechanisms added to said multiplexers in the front of X and T registers, a new instruction MUL can be added to perform a multiplication step function:

MUL If the least significant bit in X is set, route outputs from said adder to T, right-shifted by 1 bit. In the mean time, shift X to the right by 1 bit, and copy the least significant bit from said adder to the most significant bit in X. If the least significant bit in X is cleared, shift T to the right by 1 bit. In the mean time, shift X to the right by 1 bit, and copy the least significant bit in T to the most significant bit in X. Repeating this MUL instruction N times multiplies an integer in S by an integer in X, where N is the width of a program word. A double integer product is in combined T-X register pair, the most significant half in said T register, and the least significant half in said X register.

Said right shifters in front of said TMUX and said XMUX can be considered logically as a double word right shifter receiving data from said T register, said adder, and said X register. Results of said double word right shifter are routed back to said T register and said X register.

In accordance with another aspect of the invention, said XMUX in front of said X register may optionally receive data from said X register left shifted by 1 bit. The least significant bit of said data address multiplexer receives a carry bit from said adder which adds S to T. In addition, said TMUX in front of said T register is expanded to receive data from said adder or from T register, left-shifted by 1 bit, with the least significant bit in T copied from the most significant bit in X. With these mechanism added to said multiplexers in front of X and T registers, a new instruction DIV can be added to perform a division step function:

DIV If carry bit from said adder which adds S to T is set, route outputs from said adder to T, left-shifted by 1 bit. In the mean time, shift X to the left by 1 bit, and copy carry bit from said adder to the least significant bit in X. If carry bit from said adder is cleared, shift T to the left by 1 bit, and the least significant bit of T is copied from the most significant bit in X. In the mean time, shift X to the left by 1 bit, and copy said carry bit from said adder to the least significant bit in X. Repeating this DIV instruction N times divides a double integer in said T-X register pair by a negated integer in said S register, where N is the width of a program word. A quotient is in said X register, and a remainder is in said T register.

Said left shifters in front of said TMUX and said XMUX can be considered logically as a double word left shifter receiving data from said T register, said adder, and said X register. Results of said double word left shifter are routed back to said T register and said X register.

In accordance with yet another aspect of the invention, 5 input pins of said microprocessor are allocated for real time interrupts. If interrupts are enabled, and at least one of said 5 interrupt pins is asserted, a subroutine call to one of 31 locations in memory locations 1 to 31 is forced on said CPU. The location is selected by reading signals on said 5 interrupt pins, and zero-extend it to form an address pointing to a memory location between 1 and 31. By filling proper branch instructions in memory locations 1 to 31 as an interrupt vector table, said microprocessor system can respond to external interrupt requests in real time. To support real time interrupt, two more instructions are added:

| | |
|---|---|
| EI | Enable real time interrupts. |
| DI | Disable real time interrupts. |

The attainment of the foregoing and related objectives, advantages and features of the invention should be more readily apparent to those skilled in the art, after review of the following more detailed description of the invention, taken together with the drawings.

### BRIEF DESCRIPTION OF THE DRAWINGS

FIG. 1 is an overall block diagram of the scaleable microprocessor in accordance with the invention.

FIG. 2 is a block diagram of Address Processing Unit.

FIG. 3 is a block diagram of Instruction Sequencing Unit.

FIG. 4 is a timing diagram of program execution after reset RST is released.

FIG. 5 is a timing diagram of a branch instruction.

FIG. 6 is a block diagram of Data Processing Unit.

FIG. 7 is a block diagram of Address Storage Unit.

FIG. 8 is a block diagram of T and X registers to support MUL instruction.

FIG. 9 is a block diagram of T and X registers to support DIV instruction.

FIG. 10 is a block diagram of CY and UFF flip-flops to support a serial I/O port with SHR instruction.

FIG. 11 is a block diagram of INTFF and ACKFF flip-flops to service real time interrupts.

### DESCRIPTION—OVERVIEW

The scaleable microprocessor architecture of this invention is a new way in microprocessor design with special emphasis on efficiency and low power consumption appropriate for large scale System-on-a-Chip (SOC) integrated circuits. Conventional microprocessor designs take advantage of Moore's Law which states that number of gates implemented on a silicon chip doubles every 18 months, and try to integrate more functions on a chip accordingly. Resulting trend is that microprocessor chips are getting more and more complicated, and instruction sets grow larger and larger. RISC architecture tried to reverse this trend, but its success was only temporary. Initially reduced instruction sets were forced to add new instructions and functionality, and they are now indistinguishable to instruction sets in CISC microprocessors.

By adopting two stacks to store return addresses and also parameters needed by nested subroutines, microprocessor architecture can be greatly simplified without sacrificing performance, but with reduced silicon area and power consumption. It is possible to identify a minimal, efficient, and orthogonal instruction set which can solve all computational problems and form efficient representations of all computational algorithms. This invention discloses such an instruction set comprises of 20 instructions, which can be encoded in a field of 5 bits. A plurality of these instructions can be packed into program words with sizes from 15 bits up. Therefore, it is feasible to implement a series of microprocessors with word size scaleable from 15 bits up, including but not limited to 16, 24, 32, and 64 bits, and all of them execute the same instruction set. This scaleable microprocessor architecture will find applications from the smallest of embedded applications to mainframe computers hosting large Internet servers. As all these computers share the same instruction set, subroutine libraries and software tools can be shared among different computer systems, and software costs can be greatly reduced.

In the span of 30 years, Intel Corp. successfully scaled its microprocessor design from the early 8-bit 8080, to 16-bit 8086, to 32-bit 80×86, and now to 64-bit Itanium. The scaleability of its product line had ensured its customers that their software would not be obsolete on its newest microprocessors. Its customer base has snowballed for three decades and now dominates PC's on desktops, and many other microprocessor applications. Intel achieved scaleability with great difficulty, essentially embedded an old processor in a new one.

However, SOC systems will be a dominating technology in the 21th century, and complicated and power-hungry microprocessors are ill-suited to be integrated into applications which must be run on battery power. Only small, efficient processors which are easily tailored to intended applications and environments will lead new generations of microprocessor based embedded systems. This scaleable microprocessor architecture of this invention will provide the solution.

In prior art microprocessor architectures, width of program and data words is fixed and cannot be changed easily. Changing the width of program and data words has tremendous impact on design of instruction set and implementation of microprocessor circuitry. This invention conveys a unique insight that width of program and data words can be decoupled from instruction set and can be considered as a design variable to be adjusted for specific applications.

In the following discussions, all registers, stacks, multiplexers, and their connections are assumed to have the same width N in bits. The minimum width is 15 bits which hold 3 instructions. However, because commercial memory chips are all organized in 8 bit width, word size of microprocessors are conveniently chosen as multiples of 8 bits. The word size of this scaleable microprocessor architecture is thus from 15 bits up, including but not limited to 16, 24, 32, and 64 bits.

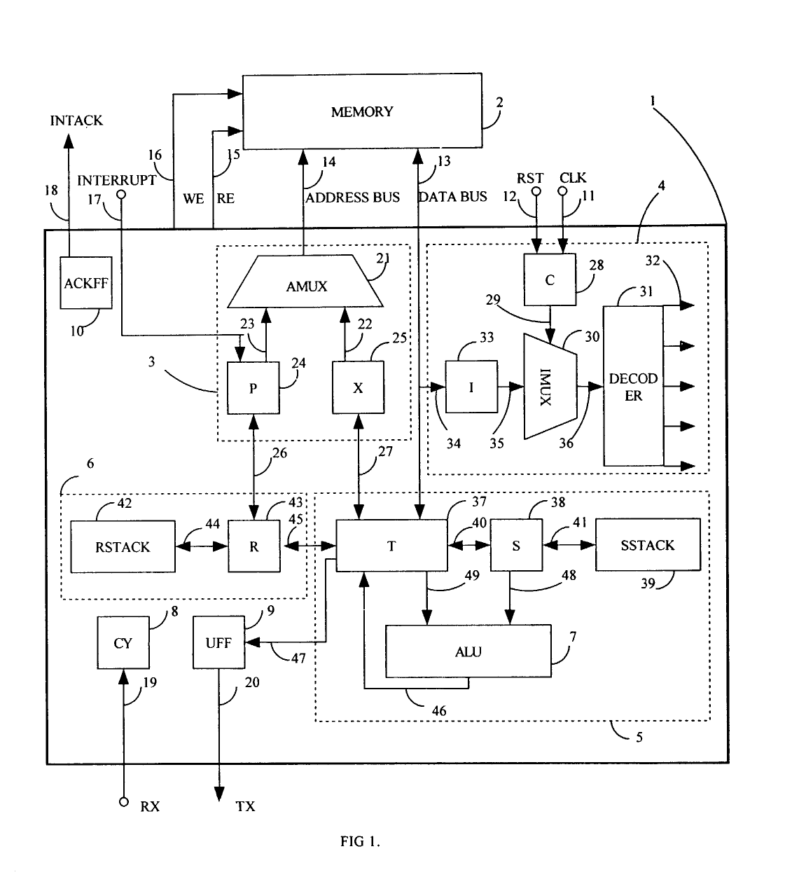

FIG. 1 —Central Processing Unit and Memory

Turning now to the drawings, more particularly to FIG. 1, there is shown block diagram of a scaleable microprocessor. Central processing unit CPU 1 contains a plurality of registers, two stacks, a plurality of logic circuits, and a plurality of multiplexers. It is also connected to an external memory device MEMORY 2 through an ADDRESS BUS 14, a bidirectional DATA BUS 13, a read-enable signal RE 15, and a write-enable signal WE 16. CPU 1 reads program words from MEMORY 2 and executes instructions contained in program words. CPU 1 also reads data from MEMORY 2, and occasionally writes data into storage locations in MEMORY 2. When CPU 1 reads program words and data words from MEMORY 2, control signal RE 15 is asserted. When CPU 1 writes data into MEMORY 2, control signal WE 16 is asserted.

The sample implementation shown in FIG. 1 assumes that memory device is of an asynchronous SRAM type. However, it does not exclude other types of memory like ROM, DRAM, and flash memory. It can be adapted to use other types of memory by modifying address bus, data bus, and control signals. In certain implementations, memory device can be integrated with CPU on the same silicon die. In this situation, it is not necessary to bring out address/data bus and control signals.

CPU 1 can be divided into 4 major blocks and some minor blocks. The 4 major blocks are address processing unit 3, instruction sequencing unit 4, data processing unit 5, and address storage unit 6. Minor blocks include the serial I/O port 8 and 9, and interrupt handler 10. Following is detailed description of circuitry connecting these blocks

(a). Reset and Master Clock

As shown in FIG. 1, central processing unit CPU 1 is controlled from the outside by two control signals: master reset RST 12 and master clock CLK 11. When said reset RST 12 is asserted, all registers and stacks inside CPU 1 are cleared. When RST 12 is released, said master clock CLK 11 paces the action in CPU 1.

On the rising edge of CLK 11, a new instruction is selected through instruction multiplexer IMUX 30 and sent to instruction decoder DECODER 31. DECODER 31 decodes the instruction and generates all internal control signals 32, which set up data paths through multiplexers, and route proper signals to inputs of registers and stacks. On the rising edge of CLK 11, selected signals are latched into appropriate registers and stacks. Thus the current instruction is completed and a new instruction is started. CLK 11 causes instructions and hence programs to be executed in sequence, one instruction per cycle on its rising edges.

As all registers and stacks are implemented in CMOS logic gates, they hold their contents indefinitely between two consecutive rising clock edges. Master clock CLK can run at frequencies from 0 Hz to a maximum frequency depending on IC process technology and detail implementation of circuit layout. Experiments using 1.2 micron CMOS process showed that the maximum frequency was about 100 MHz. It is expected that using 0.25 micron CMOS process, the maximum frequency will be about 1 GHz.

(b). Serial I/O Port

As shown in FIG. 1, address bus, data bus, and control signals are brought out from CPU 1 to MEMORY 2. All peripheral I/O devices can be mapped into memory space and connected to CPU 1 through memory busses. However, a serial I/O port connecting to a standard terminal device using RS232 protocol is extremely useful for debugging and programming purposes. This scaleable microprocessor architecture includes such a serial port in CPU 1. The receiver input RX 19 and the transmitter output TX 20 are brought to two I/O pins, along with RST 12 and CLK 11.

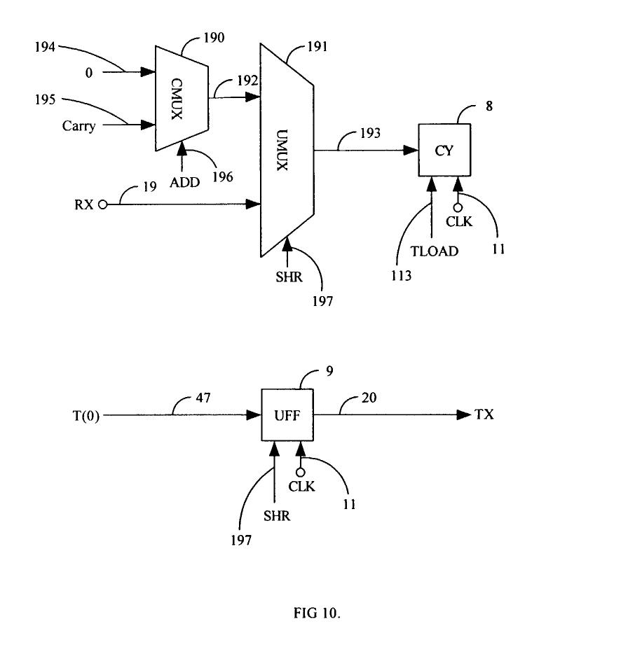

Implementation ofthis serial I/O port will be discussed later in FIG. 10. However, it is sufficient to mention here that said serial port is operated by a shift-right instruction SHR. When SHR is executed, state of input pin RX 19 is latched into carry register CY 8, and the least significant bit in register T 3 is latched into flip-flop UFF 9 through connection 47. State of UFF 9 appears instantaneously on output pin TX 20. With these simple circuits, an UART type serial I/O port can be programmed in software to transmit and receive serial data at, for example 9600 baud, to an external terminal.

(c). Interrupts

CPU 1 accepts real time interrupts from the interrupt pins INTERRUPT 17. When interrupts are enable in CPU, and at least one of the INTERRUPT pins is asserted, a subroutine call is forced to an address in the interrupt vector table, located in memory locations 1 to 31. When an interrupt is being serviced, an interrupt acknowledge signal is sent out of the pin INTACK 18. When interrupt service routine executes a subroutine return instruction, INTACK 18 is cleared.

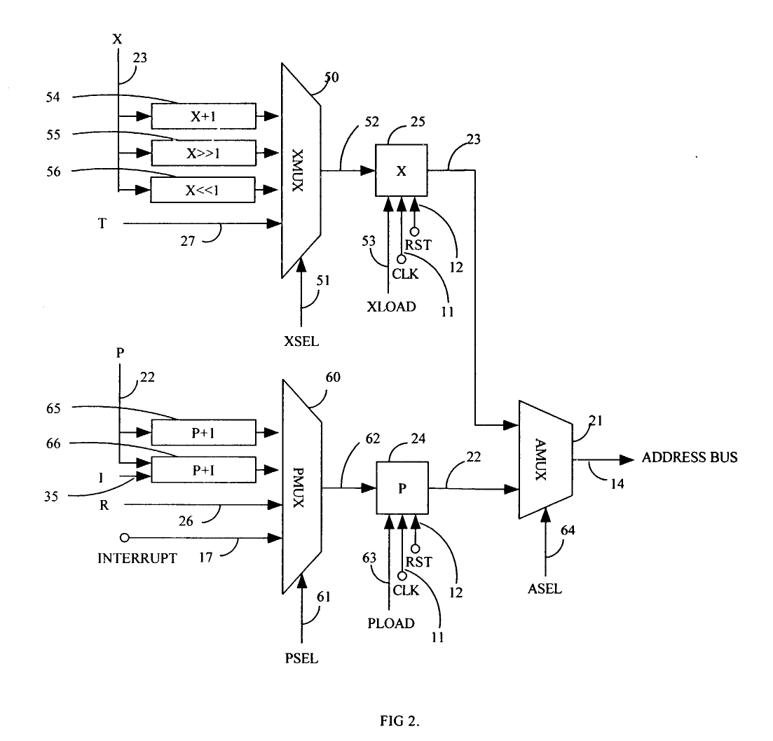

As shown in FIG. 1, there are a plurality of registers, multiplexers, and stacks inside CPU 1. They are organized into 4 major circuit blocks: address processing unit 3, instruction sequencing unit 4, data storage unit 5, and address storage unit 6. Detailed circuits in these blocks will be discussed later in association with FIG. 2-7. Here is an overview of principal registers and their functionality.

(d). Address Processing Unit

Address processing unit 3 contains program address register P 24 and data address register X 25. It supplies addresses to MEMORY 2 through memory address multiplexer AMUX 21 and ADDRESS BUS 14 to read program/data words from memory and to write data into memory.

Data address register X 25 is connected to top data register T 37 through connection 27. It provides an address to said ADDRESS BUS 14 of MEMORY 2 when CPU 1 reads data from and writes data into MEMORY. X register shares ADDRESS BUS with register P 24 through connection 22 and memory address multiplexerAMUX 21. Before reading or writing memory, a valid address must be loaded into X 25 from T 37. After reading or writing memory, address in X 25 may be optionally incremented. Optional auto-incrementing mechanism is very useful when a program must access a contiguous array of data in memory.

Program address register P 24 contains an address of next program word to be read from memory. It is connected to ADDRESS BUS 14 through connection 23 and memory address multiplexer AMUX 21. Most of the times, address in P appears automatically on ADDRESS BUS as AMUX allows address in P to flow through as default condition. When CPU 1 executes a memory read/write instruction, AMUX then routes data address in X 25 through connection 22 to ADDRESS BUS 14.

(e). Instruction Sequencing Unit

Instruction sequencing unit 4 contains instruction latch register 1 33 and instruction counter register C 28. It latches program words from MEMORY 2 into I 33 and sequences instructions in I 33 for decoding and execution..

Instruction latch register I 33 latches a program word read from MEMORY 2 through DATA BUS 13 and connection 34. As a program word contains a plurality of instructions, one instruction is selected by instruction multiplexer IMUX 30 through connection 35 and sent to DECODER 31 through connection 36. If selected instruction is a branch instruction, address field of current program word is extracted from I register 33 and sent to logic circuits in front of P register to compute address of next program word.

Instruction counter register C 28 is an up-counter driven by external control signals RST 12 and CLK 11. When RST is asserted, C is cleared and the CPU is held in initial state. All registers and stacks are cleared, and I 33 is loaded with contents of memory location 0, When RST is released, rising edge of CLK increments C 28. Count in C is sent out to instruction multiplexer IMUX 30 through connection 29, to select the first instruction in I 33 and send it to instruction decoder DECODER 31 through connection 36. Controlled by selected instruction, DECODER produces all control signals 32 to all registers and multiplexers in CPU 1. These control signals route data through logic circuits and multiplexers to appropriate registers and stacks. On the rising edge of CLK 11, selected registers and stacks will latch new data to complete current instruction cycle and to start a new instruction cycle. When the last instruction in I 33 is executed, count in C is also cleared. When C is cleared, next program word is read from memory and latched into 1 33. Subsequent rising edges on CLK will increment counter C 28 and cause instructions in I 33 to be executed in sequence.

(f). Data Processing Unit

Data processing unit 5 comprises arithmetic logic unit 7, top data register T 37, second data register S 38, and data stack SSTACK 39. It obtains data from memory and other registers for processing by ALU 7.

Top data register T 37 is the central data handling device in CPU 1, and is connected to most of other registers. It also provides one operand to arithmetic logic unit ALU 7 through connection 49, and receives results produced by ALU 7 through connection 46. T 33 also has a bidirectional DATA BUS 13 connection to MEMORY 2.

Second data register S 38 is connected to T 37 through connection 40. It provides optional second operand to ALU 7 through connection 48. It is also connected to data stack SSTACK 39 through connection 41. Contents of S register can be temporarily saved by pushing it on SSTACK. Said contents can be restored to S register by popping back from SSTACK.

Data stack SSTACK 39 is a last-in-first-out (LIFO) push-down stack to save contents in S register 38. In actual operations, registers T, S, and stack SSTACK can be thought of as a single stack. In a push operation, contents in S are pushed on the top of SSTACK, and contents in T are saved in S. In a pop operation, contents in S are copied into T, and top item on SSTACK stack is popped into S. This chain of storage devices is often called a parameter stack, which is used to pass parameters among nested subroutines, and to manipulate these parameters.

Arithmetic logic unit ALU 7 accepts two operands from T 37 and S 38 and perform arithmetic/logic operations on them. Results of operations are routed back to T37 through connection 46

(g). Address Storage Unit

Address storage unit 6 contains return address register R 43 and return stack RSTACK 42. Its principal function is to save return addresses from program address register P 24. However, it also serves as temporary storage for data in top data register T 37.

Return address register R 43 is connected to T 37 through connection 45. It is also connected to return stack RSTACK 42 through connection 44. Contents in R 43 can be temporarily saved by pushing it on RSTACK 42. Said contents can be restored to R 43 by popping them from RSTACK. R 43 is also connected to program address register P 24 through connection 26. When a subroutine call instruction is executed, address in P 24 is saved to R 43, and contents in R 43 are pushed on RSTACK 42. When a subroutine return instruction is executed, address in P 24 is restored from R 43, and top item on RSTACK 42 is popped back into R 43.

Return stack RSTACK 42 is a last-in-first-out (LIFO) push-down stack to save contents in R 43. In actual operations, R 43 and RSTACK 42 can be thought of as a single stack. In a push operation, contents in R 43 are pushed on SSTACK 42, and contents in T 37 or P 24 are saved in R 43. In a pop operation, contents in R 43 are copied into T 37 or P 24, and top item on RSTACK 42 is popped into R 43.

As implied in FIG. 1, said return stack RSTACK 42, said registers R 43, T 37, S 38 in that order, and said data stack SSTACK 39 can be considered a giant array of connected shift registers, with the R-T-S triad forming a sliding window exposed to other circuitry in CPU 1. A push operation moves this sliding window to the right, and a pop operation moves the sliding window to the left.

FIG. 2—Address Processing Unit

FIG. 2 shows address processing unit 3 comprising of program address P 24, address register X 25, and their respective multiplexers and associated circuits. These two registers provide addresses to ADDRESS BUS 14 through address multiplexer AMUX 21.

Registers P 24 and X 25 have global control signals RST 12 and CLK 11 brought to them. When RST is asserted, P and X are cleared and 0 is sent to ADDRESS BUS 14 through connection 22 and multiplexer AMUX 21, because ASEL 64 always selects P to pass AMUX as default. When RST 12 is released, memory word at location 0 is read from MEMORY 2 and latched into instruction register I 33.

When PLOAD 63 is asserted, the next rising edge of CLK 11 causes data supplied from multiplexer PMUX 60 through connection 62 to be latched into P 24. When PLOAD is released, CLK is ignored by P and contents of P do not change.

PSEL 61 allows PMUX 60 to pass one of following four signals to P 24:

| | |
|---|---|
| (P+1) 65: | Program address incrementer. P 24 is incremented to point to next program |
| | word in MEMORY 2. |
| (P+I) 66: | Program address adder. When a branch instruction is executed, address of next |
| | program word is computed from contents in P 24 through connection 22 and address field of current |
| | program word in I 33. There are two models to compute this new address for storing into P 24. In |
| | relative branching model, contents in the address field is sign-extended and added to current program |
| | address in P register to form an address of next program word. In page-absolute branching model, |
| | contents in address field are extracted and replace the same portion of address in current program |
| | address. In actual implementation one of these models must be chosen. |
| R 26: | Return address register. When a subroutine return instruction RET is executed, |
| | PSEL 61 routes contents in R 43 through connection 26 to P 24. Return address in R 43 is restored to |
| | P 24 and program resumes from the location interrupted by previous subroutine call. |
| INTERRUPT 17: | Interrupt input. If microprocessor system supports real time interrupts, PSEL |
| | 61 lets interrupt vector through PMUX 60 to be latched into P 24. INTERRUPT 17 are connected |
| | directly to 5 interrupt input pins of said CPU 1, and interrupt vector is the current state of these |
| | interrupt input pins, zero-extended to fill a program word. If interrupts are enabled, and at least one |
| | of the 5 interrupt pins is asserted, a subroutine call to one of 31 locations in MEMORY 2 locations 1 to |
| | 31 is forced on CPU 1 when CPU 1 is fetching next program word. An interrupt service routine is |
| | selected by reading signals on 5 interrupt pins, and zero-extend it to form an address pointing to a |
| | memory location from 1 to 31. By filling appropriate branch instructions in MEMORY 2 locations 1 |
| | to 31, CPU 1 can respond to external interrupt requests in real time. |
| | FIG. 2 also shows register X 25 and its associated data address multiplexer XMUX 50. X 25 supplies |
| | address for memory read instruction LD and memory write instruction ST. When a LD or ST |
| | instruction is executed, control signal ASEL 64 is asserted, and routes address in X 25 through |
| | connection 23 and multiplexer AMUX 21 to ADDRESS BUS 14, which selects proper memory |
| | location in MEMORY 2 for reading or writing. |
| | Registers X 25 has global control signals RST 12 and CLK 11 brought to them. When RST is |
| | asserted, X is cleared. When RST is released, new data will be latched into X 25 if XLOAD 53 is |
| | asserted. When XLOAD is released, CLK is ignored by X 25 and contents of X will not change. |
| | When XLOAD 53 is asserted, next rising edge of CLK causes data supplied from multiplexer XMUX |
| | 50 through connection 52 to be latched into X 25. XSEL 51 allows XMUX 50 to pass one of following |
| | signals to X register: |
| T 27: | Top data register. Contents in T 37 are routed to X 25 through connection 27 and |
| | multiplexer XMUX 50. X 25 always obtains new address from T. However, when X is not used to |
| | address memory, it can be used as a temporary storage register for T. |
| (X+1) 54: | Address register incrementer. X is incremented by 1. |
| (X>>1) 55: | Address right shifter. X is shifted to right by 1 bit. It is used by MUL instruction to |
| | do a multiplication step. If X(0)=1, the most significant bit of X is replaced by the least significant bit |
| | in adder 102, which produces (T+S). If X(0)=0, the most significant bit of X is replaced by the least |
| | significant bit of T; i.e., T(0). |
| (X<<1) 56: | Address left shifter. X is shifted to left by 1 bit. It is used by DIV instruction to do a |
| | division step. The least significant bit in X is replaced by the carry bit produced by the adder 102. |

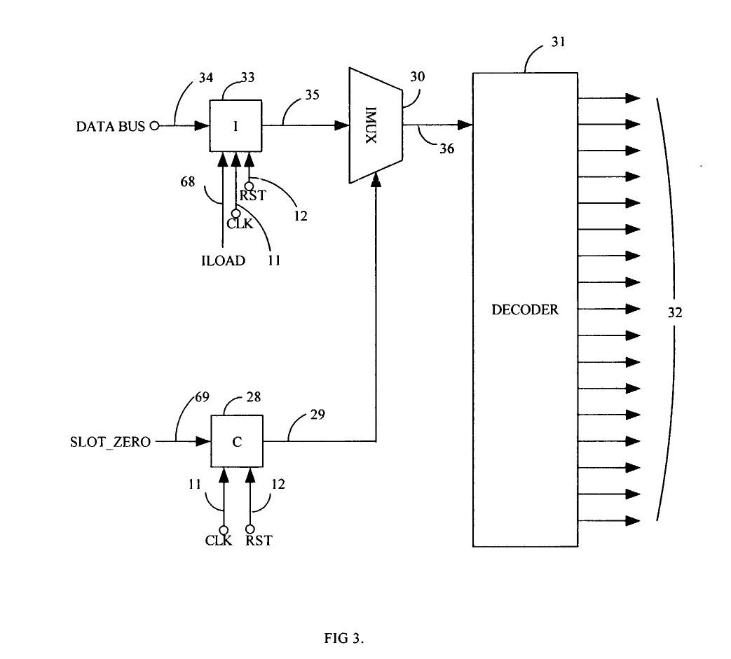

FIG. 3—Instruction Sequencing Unit

FIG. 3 shows a more detailed view of instruction sequencing unit 4, comprising of instruction register I 33, instruction counter C 28, instruction multiplexers IMUX 30, and instruction decoder DECODER 31.

Registers I 33 and C 28 have global control signals RST 12 and CLK 11 brought to them. When RST is asserted, I and C are cleared. When RST is released, l 33 will latch in a new program word from DATA BUS 34 on the rising edge of CLK, when ILOAD 68 is asserted. When ILOAD 68 is released, CLK is ignored by I 33 and contents of I 33 do not change.

When RST is released, instruction counter C 28 will increment on the rising edge of CLK. Count in C 28 is sent through connection 29 to control instruction multiplexer IMUX 30. C 28 select one instruction in current program word latched in 1 33. Selected instruction is sent to DECODER 31 through connection 36. DECODER 31 produces selection signals in 32 to multiplexers in CPU 1 and enable signals in 32 to registers, and stacks in CPU 1. Selection signals to multiplexers route proper data to registers and stacks, so that on the rising edge of CLK, selected data will be latched into enabled registers and stacks.

As a plurality of instructions are packed into a program word, and number of instructions in a program word depends on word size of implemented microprocessor, and on the position of branch instruction, if any, in a program word. Whatever number of instructions might be in a program word, when the last instruction is executed, a signal SLOT_ZERO 69 is asserted. When SLOT_ZERO is asserted, count in C is cleared on the rising edge of CLK. In next clock cycle, as count in C is cleared, CPU 1 executes a program word read operation and latches next program word into I 33 from DATA BUS 34 selected by address in P 24 routed to MEMORY 2 through ADDRESS BUS 14. In next few clock cycles, instructions are selected from I 24 through multiplexer IMUX 30 into DECODER 31. This process continues indefinitely to read program words and execute instructions in them.

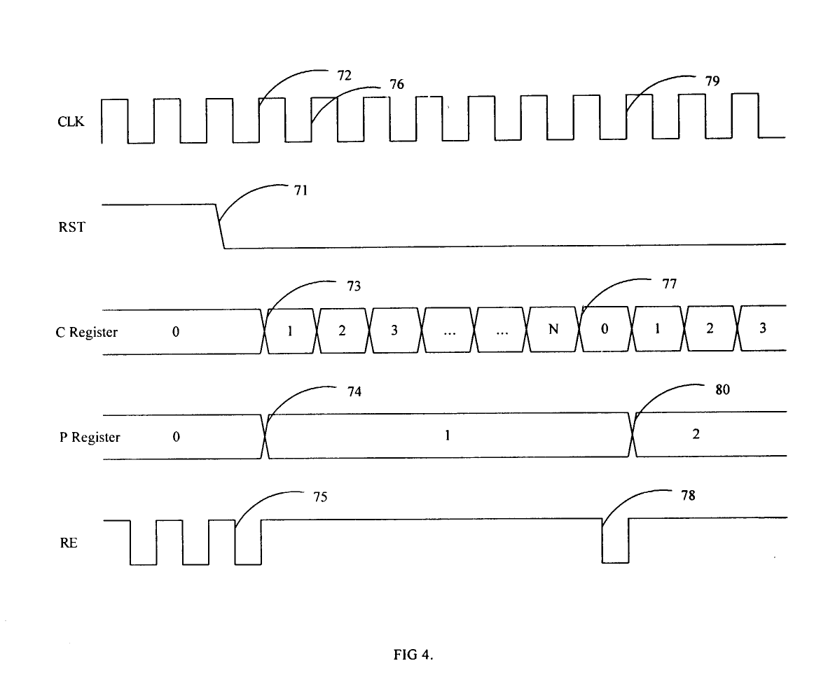

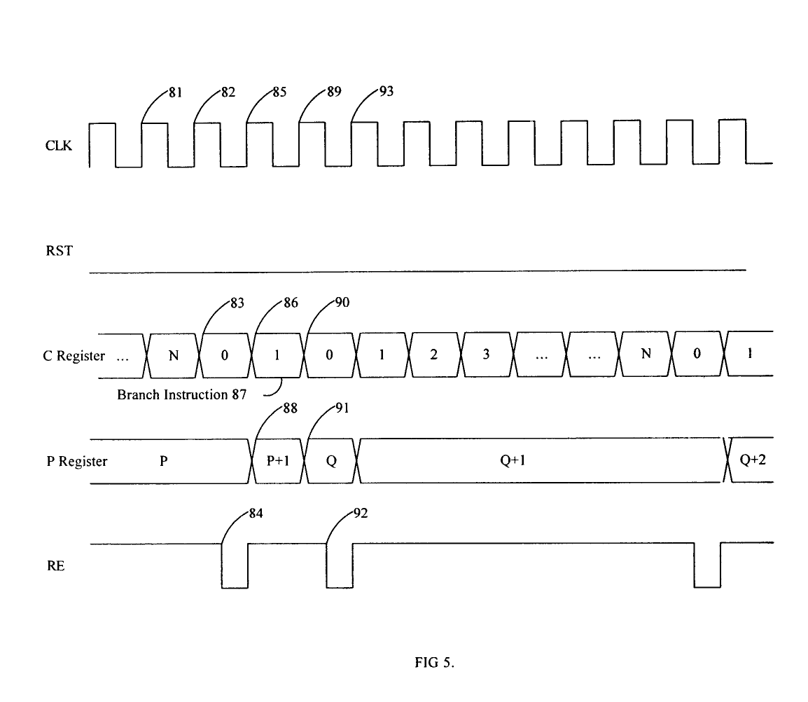

FIGS. 4-5—Timing Diagrams

FIG. 4 and FIG. 5 show timing diagrams of the instruction sequencing unit 4. FIG. 4 shows several clock cycles after clock edge 71 when master reset RST 12 is changed from being asserted to being released. When RST is asserted, all registers and stacks are cleared. As shown in FIG. 4, contents in C 28 and P 24 are both cleared, allowing execution to start with a program word stored in MEMORY 2 location 0, loaded into I 33. Memory control signal read-enable RE 15 is asserted at 75 in the second half of CLK 11. MEMORY 2 places contents of location 0 on DATA BUS 13 to be latched into I 33.

After RST is released at 71, the next rising edge of CLK 72 starts instruction sequencing, and P 24 is incremented to 1 on transition 74. Counter C 28 is also incremented to 1 on transition 73, which selects the first instruction in I 33 to be executed. On the rising edge of next clock 76, counter C 28 is incremented to 2 and starts executing the second instruction in I 33. This sequence continues until all instructions in I 33 are executed.

When the last instruction in I 33 is executed, counter C 28 is cleared to 0 at 77. In next clock cycle, RE 15 is asserted at 78, and program word in memory location I is read out on DATA BUS 13. On the rising edge of next clock 79, a new program word is latched into I 33, program address in P 24 is incremented to 2 at 80, and counter C 28 is incremented to 1. In subsequent cycles instructions in I 33 are executed.

FIG. 5 shows timing diagrams of a branch instruction. Rising edge of CLK at 81 starts executing last instruction in the last program word. On rising edge of CLK 82, counter C 28 is cleared and CPU 1 is ready to read in next program word. Read-enable signal RE 15 is asserted at 84, and MEMORY 2 puts next program word on DATA BUS 13. On the rising edge of next clock at 85, a new program word 87 is latched into I 33 at 86. This new word contains a single branch instruction. While reading in a new program word, P 24 is incremented to P+1 at 88.

On the rising edge of CLK 89, said branch instruction is decoded and executed at 90. The consequence is that a new address Q is computed and latched into P 24 at 91. Counter C 28 is also cleared at 90, and a new program word read operation is started at 92. On the rising edge of CLK at 93, new program word in memory location Q is latched into I 33, P 24 is incremented to Q+1, and counter C 28 is incremented to 1. First instruction in I 33 is decoded and executed, and the sequence continues on.

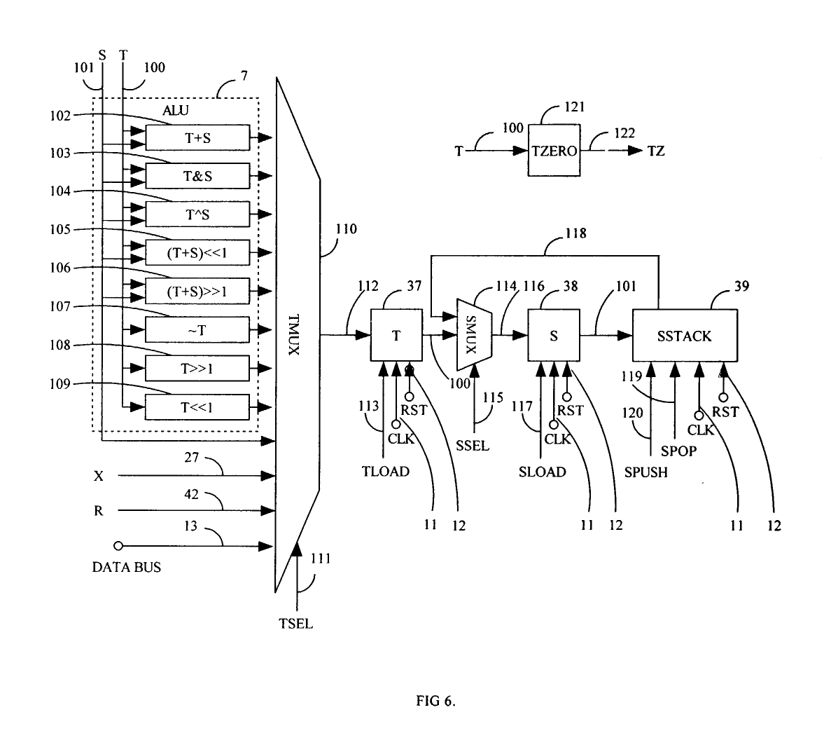

FIG. 6—Data Processing Unit

FIG. 6 is a more detailed view of data processing unit 5, comprising of ALU 7, T register 37, S register 38, top data multiplexer TMUX 110, second data multiplexer SMUX 114, and data stack SSTACK 39.

Registers T 37, S 38, and SSTACK 39 have global control signals RST 12 and CLK 11 brought to them. When RST is asserted, T, S and SSTACK are all cleared. When RST is released, T, S and SSTACK latch in new data on the rising edge of CLK, depending on enable signals TLOAD 113, SLOAD 117, SPUSH 120, and SPOP 119.

When TLOAD 113 is asserted, the next rising edge of CLK 11 causes data supplied from top data multiplexer TMUX 110 through connection 112 to be latched into T register. When TLOAD 113 is released, CLK is ignored by T and contents of T do not change.

When SPUSH 120 is asserted, data storage unit is in a push state. The next rising edge of CLK caused data from S 38 through connection 101 to be pushed on data stack SSTACK 39, and data in T 37 is latched into S 38 through connections 100, 116 and SMUX 114. When SPOP 119 is asserted, data storage unit is in a pop state. The next rising edge of CLK caused SSTACK 39 to be popped; i.e., its top item is discarded. However, said top item is copied into S 38 through connections 118, 116 and multiplexer SMUX 114, as selected by SSEL 115. In the mean time, data in S 38 is copied into T 37 through connections 101, 112 and multiplexer TMUX 110. When enable signals SPUSH and SPOP are both released, CLK is ignored by SSTACK and contents of SSTACK do not change.

When SLOAD 117 is asserted and data storage unit is in a push state, the next rising edge of CLK caused data from T 37 through connections 100, 116 and SMUX 114 to be latched into S 38. When SLOAD is asserted and data storage unit is in a pop state, the next rising edge of CLK caused data from SSTACK through connections 118, 116 and SMUX 114 to be latched into S 38. When SLOAD is released, CLK is ignored by S and contents of S do not change.

TZERO 121 block is a zero detecting circuit for T 37. All bits in T 37 are fed through connection 100 into a giant NOR gate, and resulting signal TZ 122 can be tested by a branch on zero instruction BZ to do a conditional branch based on state of TZ.

As shown in FIG. 6, arithmetic logic unit ALU 7 works with T 37, S 38, and top data multiplexer TMUX 110 in front of T. It is very import to emphasize that ALU 7 contains only random logic circuits and has no latch or other storage elements. ALU 7 takes in one operand from T 37 and an optional operand from S 38. Operands from T and S thus flow through circuitry in ALU 7 and produce following resulting signals routed towards top data multiplexer TMUX 110:

| | |
|---|---|
| (T+S) 102: | Adder. Sum of T and S. This is the adder hereby |
| | referred to. |
| (T&S) 103: | AND gates. AND'ing T and S. |
| (T\hat{ }S) 104: | Exclusive OR gates. Exclusive Or'ing of T and S |
| ((T+S)<<1) 105: | Adder left shifter. Sum of T and S, shifted to left by 1 |
| | bit |
| ((T+S)>>1) 106: | Adder right shifter. Sum of T and S, shifted to right by |
| | 1 bit |
| (˜T) 107: | Inverting gates. One's complement of T |
| (T<<1) 108: | Top left shifter. T shifted to left by 1 bit |
| (T>>1) 109: | To right shifter. T shifted to right by 1 bit |

ALU 7 is always active, and resulting signals change with input operands from T and S. Different ALU instructions merely select proper results, route them through TMUX 110 with proper control signal TSEL 111, and latch them into T 37 on the next rising edge of CLK. The longest delay in producing these results determines maximum clocking frequency of this CPU. Most likely adder 102, used also in blocks 105 and 106, has the longest delay and is the critical path of this design. However, this simple ‘compute before selecting’ scheme allows all ALU instructions to be completed in a single clock cycle with minimal hardware circuitry.

Besides selecting results from ALU 7, T 37 also obtains data from X 27, R 42, and DATA BUS 13 through top data multiplexer TMUX 110.

Not shown in FIG. 2 is circuitry associated with a carry bit from adder 102. The carry bit from adder 102 is only latched into register CY 8 when an ADD instruction is executed. In all other situations (except SHR instruction) CY 8 is cleared. Control circuits of CY register is shown more clearly in FIG. 10.

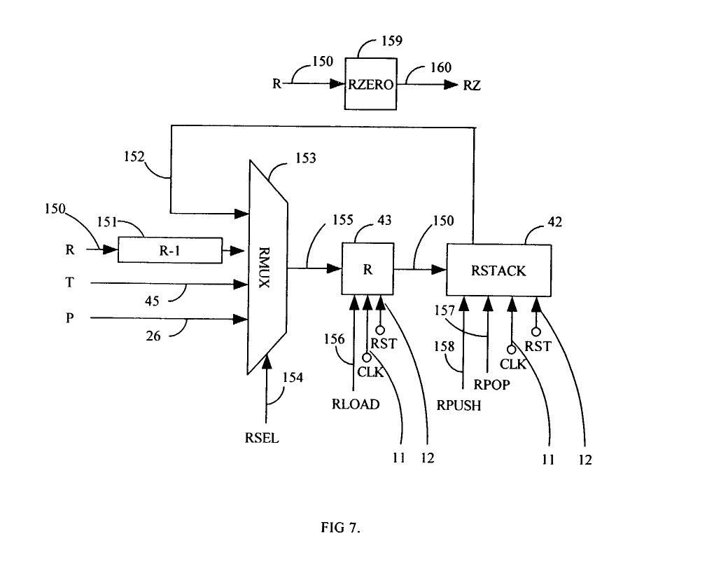

FIG. 7—Address Storage Unit

FIG. 7 is a more detailed view of address storage unit 6, comprising of return stack RSTACK 42, return address register R 43, and return address multiplexer RMUX 153. R 43 and RSTACK 42 have global control signals RST 12 and CLK 11 brought to them. When RST is asserted, R 43 and RSTACK 42 are all cleared. When RST is released, R 43 and RSTACK 42 will latch in new data on the rising edge of CLK, depending on enable signals RLOAD 156, RPUSH 158, and RPOP 157.

When RPUSH 158 is asserted, address storage unit is in a push state. The next rising edge of CLK causes data from R 43 through connection 150 to be pushed on return stack RSTACK 42. When RPOP 157 is asserted, address storage unit is in a pop state. The next rising edge of CLK causes RSTACK 42 to be popped; i.e., its top item is discarded. However, said top item is copied into R 43 through connections 152, 155 and multiplexer RMUX 153, as selected by RSEL 154. When RPUSH and RPOP are released, CLK is ignored by RSTACK and contents of RSTACK do not change.

When RLOAD 156 is asserted and address storage unit is in a push state, the next rising edge of CLK causes data supplied from return address multiplexer RMUX 153 through connection 155 to be latched into R 43. When RLOAD is asserted and address storage unit is in a pop state, the next rising edge of CLK 11 causes data from RSTACK 42 through connections 152, 155 and RMUX 153 to be latched into R 43. When RLOAD is released, CLK is ignored by R and contents of R do not change.

Besides saving data to RSTACK 42 and restoring data from RSTACK, R 43 takes input signals from T 37 and P 24 through connection 45, 26 and return address multiplexer RMUX 155. It is also auto-decremented by the decrementing circuit (R−1) 151 through RMUX, which is controlled by selecting signals RSEL 154.

Connection 45 links RSTACK 42 and R 43 to T 37, S 38 and SSTACK 39 to form a giant shift register array as mentioned before.

Connection 26 allows an address in P 24 to be pushed and saved on return stack. This operation allows subroutine calls to be nested. The nesting level is as deep as RSTACK 42. Studies in prior art showed that 16 levels of return stack are adequate for small application, and 32 levels are enough for very large applications.

R 43 is also auto-decremented through decrementing circuit (R−1) 151. This mechanism is useful in that R 43 can serve as a loop counter if a LOOP instruction is implemented. LOOP instruction, like all other branch instructions, has an address field. When LOOP instruction is executed, R 43 is tested for zero. If R=0, the loop is terminated. The zero count is popped off return stack, and next program word is fetched and execution continues after LOOP. If R is not 0, it is decremented and execution loops back to the address specified in address field of LOOP instruction.

RZERO 159 is a zero detecting circuit for R 150. All bits in R 43 are fed into a giant NOR gate through connection 150, and resulting signal RX 160 is tested by LOOP instruction to terminate a loop.

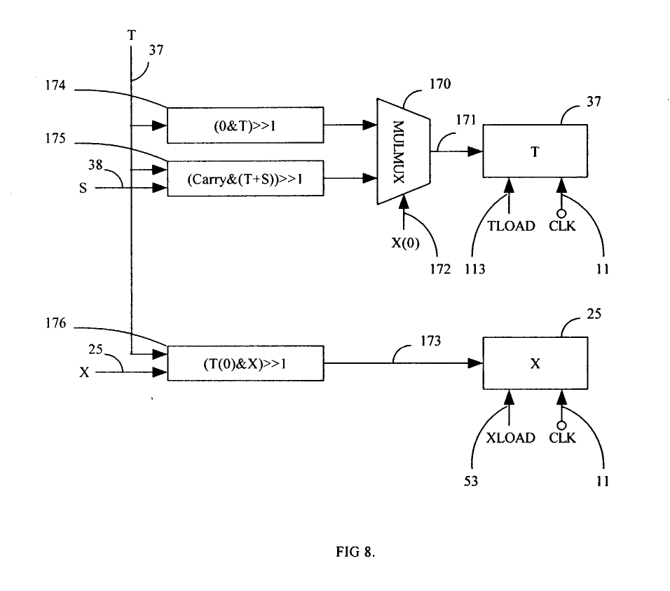

FIG. 8—Multiplication Step Instruction

FIG. 8 shows how T 37, S 38, and X 25 registers are coordinated to implement multiplication step instruction MUL. Logically T 37 and X 25 are connected to form a double integer shifter, with T 37 holding the most significant half of said double integer and X 25 holding the least significant half. Initially, T 37 contains a partial sum, X 25 contains a multiplier and S 38 contains a multiplicand. If the least significant bit of X, X(0), is set, S is added to T and T-X register pair is shifted right by 1 bit. If the least significant bit of X, X(0), is cleared, T-X register pair is shifted right by 1 bit without doing addition. Since CPU 1 already has an adder 102 to produce sum of (T+S), MUL instruction only needs an additional double integer right shifter.

When instruction MUL is executed, as shown in FIG. 8, X(0) 172 causes multiplexer MULMUX 170 to select either sum of (T+S) or T 37 right-shifted, and routes results to T through connection 171. Top right shifter 174 ((0&T)>>1) gets signals from T 37 and shift it right by 1 bit. Adder left shifter 175 (Carry&(T+S)>>1) gets sum (Carry&(T+S)) from adder 102 and shift it right by 1 bit. Instruction MUL asserts TLOAD 113, and on the rising edge of CLK 11, shifted results are latched into T 37 through multiplexer MULMUX 170 and connection 171.

Instruction MUL also asserts XLOAD 53, and causes X 25 to load results of address right shifter 176, which shifts contents of X 25 right by 1 bit, with the most significant bit in X replaced by the least significant bit of T 37.

To multiply two integers producing a double integer product, initially T 37 is cleared, a multiplier is loaded into X 25, and a multiplicand is loaded into S 38. Repeating MUL instruction N time leaves a double integer product in T−X register pair. Multiplicand in S is not changed. Number of repetition N is equal to width of program word.

If initially T 37 is not 0, but contains an integer, going through above procedure will produce a double integer sum equal to T+(S*X). This is a multiply-accumulate (MAC) operation used by many digital signal processors (DSP). It is accomplished with MUL instruction with very little additional hardware and software overhead.

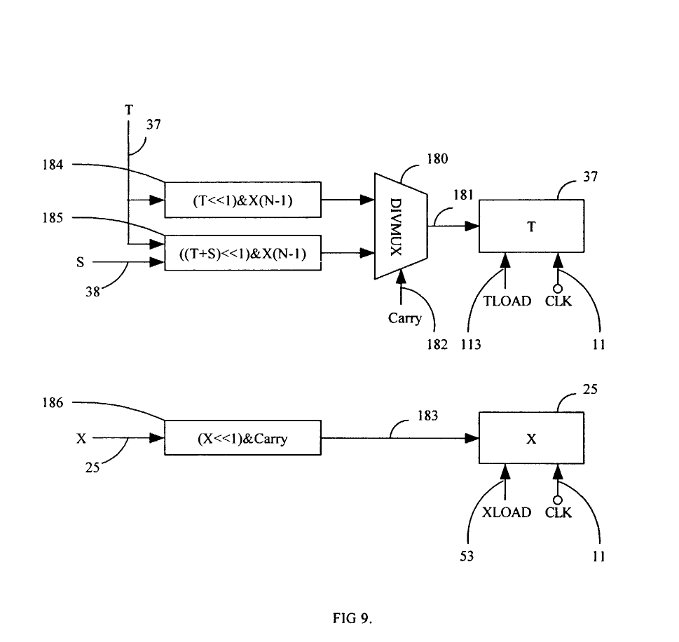

FIG. 9—Division Step Instruction

FIG. 9 shows how T 37, S 38, and X 25 registers are coordinated to implement division step instruction DIV. Logically T 37 and X 25 are connected to form a double integer shifter, with T holding the most significant half of a double integer dividend, and X holding the least significant half. Initially, S 38 contains negative value of a divisor. As adder 102 in ALU is always active in producing sum of (T+S), carry bit from adder 102 is also available. If carry from adder 102 is set, S 38 is added to T 37 and T−X register pair is shifted left by 1 bit. If carry is cleared, only T−X register pair is shifted left by 1 bit without doing addition. The least significant bit in X is replaced by carry from adder 102. Since CPU 1 already has adder 102 to produce sum of (T+S), DIV instruction only needs an additional double integer left shifter.

When DIV instruction is executed, as shown in FIG. 9, carry bit 182 from adder 102 causes multiplexer DIVMUX 180 to select either top left shifter ((T<<1)&X(N−1)) 184 or adder left shifter (((T+S)<<1)&X(N−1)) 185, and routes results to Tthrough multiplexer DIVMUX 180 and connection 181. Top left shifter 184 shifts signals from T 37 left by 1 bit and appends the most significant bit of X to T(0). Adder left shifter 185 shifts sum of (T+S) left by 1 bit, and appends the most significant bit of X to T(0). DIV instruction asserts TLOAD 113, and on the rising edge of CLK 11, shifted results are latched into T register through multiplexer DIVMUX 180 and connection 141.

DIV instruction also asserts XLOAD 53, and causes X 25 to load results of address left shifter 186, which shifts contents of X left by 1 bit, with the least significant bit in X replaced by carry bit from adder 102.

To divide a double integer dividend by a single integer divisor, initially the most significant half of a dividend is loaded into T, the least significant half of said dividend is loaded into X, and negative value of a divisor is loaded into S. Now, repeating DIV instruction (N+1)time will leave a quotient in X. The value left in T must be right shifted by 1 bit to yield a remainder of division. Number of repetition N is equal to width of program word.

Since a divisor must be negated before being placed in S register, this division procedure is valid only for positive double integer dividend and positive divisor. It is not valid when either dividend or divisor is negative.

FIG. 10—Serial I/O Port

In all prior art microprocessor architecture designs, I/O devices are not considered to be components in CPU. However, recognizing the importance of at least one I/O device in the form of a UART for debugging and testing microprocessor core at development stage, and for program downloading, initializing, and even re-programming in the final products, current invention optionally includes a simple mechanism to implement a UART type I/O device with one transmitter and one receiver. Both transmitter and receiver are implemented around top data register T 37, in association with arithmetic right shift SHR instruction.

As shown in FIG. 10, when a SHR instruction is executed, control signal 197 and enable signal TLOAD are asserted. The least significant bit of T, T(0) 47, is shifted into a flip-flop UFF 9, on the rising edge of CLK 11. Output of UFF is connected directly to an output pin TX 20, which is the transmitter of serial I/O port.

To transmit an ASC11 character out of TX 20, an 8-bit ASCII character is placed in T, in a field of T(8:1). T(0) is cleared as a start bit, and two bits T(10,9) are set as stop bits. A SHR instruction asserts control signal 197, and allows T(0) to be latched into flip-flop UFF 9, on the rising edge of CLK 11. Content of UFF 9 appears instantaneously on output pin TX 20. SHR instruction is executed 11 times to shift 11 bit pattern in T(10,0) out of TX 20. In between two consecutive SHR instructions, a software delay loop is inserted to sustain each bit a necessary bit-delay-time. Bit-delay-time can be set to match baud rate of external terminal device.

When a SHR instruction is executed, enable signal TLOAD 113 and control signal 197 are asserted, and the state of input pin RX 19 is latched into flip-flop CY 8, through connection 193, and multiplexer UMUX 191. RX 19 is selected by UMUX 191 to connection 193 as control signal 197 is asserted.

The state of RX19 is latched into CY 8 as enable signal TLOAD is also asserted, on the rising edge of CLK 11. RX 19 is thus the receiver of serial I/O port.

To receive an ASCII character from the RX 19, CPU 1 first enters a wait loop. In the wait loop, a branch on carry (BC) instruction is executed following a SHR instruction, to detect a start bit in front of an ASCII character. After start bit is detected, CPU 1 waits for half of a bit-delay-time, and executes a SHR instruction to samples RX 19 after one bit-delay-time interval. The state in CY is then stored into bit T(7) using a branch-on-carry (BC) instruction in a short input processing subroutine. After repeating this procedure 8 times, T(7:0) contains the input ASCII character.

FIG. 10 also shows a carry multiplexer CMUX 190 before multiplexer UMUX 191. CMUX is used to load carry 195 from (T+S) adder 102 into carry register CY 8 when an ADD instruction is executed. ADD instruction asserts control signal 196 and enable signal TLOAD, while releases control line 197. Carry on 195 is routed through CMUX 190, connection 192, and UMUX 191, to connection 193. On the rising clock of CLK 11, state of carry 195 from adder 102 is latched into CY 8.

All branching, ALU, register, and memory instructions except ADD and SHR pass a 0 on 194 to connection 193 through CMUX 190, connection 192, and UMUX 191, because both control signals 196 and 197 are cleared.

Since a SHR instruction shifts T(0) bit out of TX 20, it must be used carefully so that it does not disturb the serial output port unexpectedly. When SHR is used outside ofASCIl transmit loop, it is a safe practice to set bit T(0) before executing SHR. If a zero in T(0) were sent out of TX 20, external terminal device would mistakenly interpret it as a start bit of a new ASCII character.

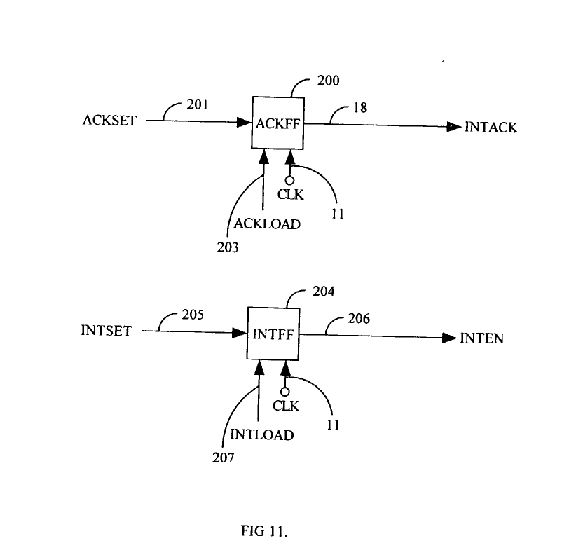

FIG. 11—Interrupt Handler

FIG. 11 shows two flip-flops presenting status of an interrupt handler. INTFF 204 generates interrupt-enable signal INTEN 206. ACKFF 200 generates interrupt-acknowledge signal INTACK 18, which goes to an output pin of CPU 1.

Interrupt pins INTERRUPT 17 are allocated for real time interrupt signals. The state of INTERRUPT 17 is examined when CPU 1 is reading next program word into I 33. If INTERRUPT 17 is not cleared and interrupt is enabled, a 5 bit value in INTERRUPT 17 is zero-extended to form an address, which is an interrupt vector, pointing to one location from 1 to 31 in MEMORY 2. Current address in P 24 is saved to R 43 and R is pushed on return stack RSTACK 42, and said interrupt vector is latched into P 24. INTERRUPT thus forces a subroutine call to one of memory locations from 1 to 31, which is an interrupt vector table. By filling interrupt vector table with branch instructions jumping to proper interrupt service routines, this CPU can correctly handle real time interrupts after interrupts are enabled.

As shown in FIG. 11, interrupt acknowledge INTACK 18 is asserted when CPU 1 starts servicing an interrupt and asserts ACKSET 201 and ACKLOAD 203. On the rising edge of CLK 11, state of ACKSET is latched in ACKFF 200 and output to INTACK 18. INTACK 18 is cleared when interrupt service routine encounters a return instruction RET, which clears ACKSET 201 and asserts ACKLOAD 203. On the rising edge of CLK 11, ACKSET is latched into ACKFF 200 and INTACK 18 is cleared. INTACK 18 provides necessary handshake signal to external devices which request interrupt services. When the device requesting interrupt service senses that INTACK 18 is asserted, it must remove its interrupt request signal placed on INTERRUPT 17.

When CPU 1 powers up, interrupts are disabled as interrupt enable flip-flop register INTFF 204 is cleared and its output INTEN 206 is also cleared. When INTEN is cleared, interrupts are disabled. When interrupt enable instruction El is executed, both INSET 205 and INTLOAD 207 are asserted. On the rising edge of CLK 11, state of INTSET 205 is latched in INTFF 204 and output INTEN 206 is also asserted. When INTEN 204 is asserted, external interrupt request will cause interrupt when CPU 1 is fetching next program word.

When CPU 1 fetches next program word from MEMORY 2, state of INTEN 206 is examined. If INTEN is cleared, next program word is fetched from MEMORY 2 and executed. However, if INTEN is asserted and if at least one of 5 INTERRUPT pins is asserted, an interrupt service call is forced on CPU. Address of next program word in P 24 is saved to R 43 and R is pushed on RSTACK 42. Address of interrupt service subroutine is formed by state of INTERRUPT 17, zero-extended to form a program word address. This address points to a location in MEMORY 2 from 1 to 31. Calling a subroutine in one of these locations activated one interrupt service. At the same time, INTSET 205 is released and INTLOAD 207 is asserted. On the rising edge ofCLK 11, INTSET 205 is latched into INTFF 204, and thus clears INTEN 206. From now on, further interrupts are disabled.

While entering an interrupt service, INTSET 205 is cleared, and INTLOAD 207, ACKSET 201, and ACKLOAD 203 are asserted. One the rising edge of CLK, ACKFF 200 and INTACK 18 are both asserted. INTACK 18 is connected to an output pin, and it tells external interrupt devices that a requested interrupt service is in progress. However, INTFF 204 and INTEN 206 are both cleared, and thus disable further interrupts.

When a subroutine return instruction RET is executed, ACKSET 201 is cleared and ACKLOAD 203 is asserted. On the rising edge of CLK, ACKFF 200 and INTACK 18 are both cleared. Since an interrupt service routine is always terminated by a RET instruction, INTACK 18 is cleared after interrupt service routine is completed. Executing interrupt disable instruction DI has same effect in disabling interrupts. CPU 1 will not respond to further interrupts until an interrupt enable instruction EI is executed.

It is assumed that an interrupt device requests interrupt service by asserting one bit in INTERRUPT 17. After CPU 1 enables interrupts by executing interrupt enable instruction EI, it tests interrupt request when it is fetching a program word and calls corresponding interrupt service routine if one or more bits in INTERRUPT 17 is asserted. CPU also raises INTACK 18 to inform interrupt devices that an interrupt is being serviced. Seeing that INTACK 18 is set, interrupting devices must remove its interrupt request so that interrupt service is not repeated unnecessarily. As hardware interrupt handler disables further interrupts by clearing INTFF 204 and INTEN 206 when an interrupt is being serviced, interrupt request can persist for a while. However, interrupt request must be removed before CPU executes an EI instruction again. Otherwise, persisting interrupt request will cause the same interrupt to repeat.

Advantages

From the description above, a number of advantages of this scaleable microprocessor architecture become evident:

(a). A simple, efficient, and orthogonal instruction set embodied the essence of a computer, which can express all computing algorithms efficiently. Design of this scaleable microprocessor architecture follows goals guiding the original RISC architecture, but goes further in removing redundancy in RISC instruction sets. Computers using this simple instruction set is smaller, faster, consuming less power, and more economical to manufacture. It is apparent that this scaleable microprocessor architecture has superior characteristics measured against existing CISC, RISC, and stack-based architectures. These characteristics are more important now that microprocessor systems are evolving toward System-on-a-Chip (SOC), integrating millions of gates in a single integrated circuit. This scaleable microprocessor architecture responds to the needs in new generations of very large scale integrated circuits.

(b). A simple instruction set allows the size of program words to be easily scaled from 15 bit up, and effectively removes limitations imposed on computer architectures by a fixed program word size. Program word size is no longer a critical architectural limitation, but a design parameter which can be customized to suit specific applications. This unique feature of scaleable microprocessor architecture is a great improvement over prior art CISC, RISC and stack architectures because all prior art designs were tied firmly to specific program word sizes. All prior art computer architectures are non-scaleable. It thus took Intel 30 years to move its architecture from the lowly 8-bit 8080, through 16-bit 80186/80286 and 32-bit 80386/80486/Pentium, to 64-bit Itanium. Using this scaleable architecture with 5-bit instructions, computers with 16-, 24-, 32-, and 64-bit program words were constructed easily, and demonstrated that they could all executed the same instruction streams and supported nearly identical operating systems.

(c). Effective use of an address register eliminates the needs of various addressing modes required by CISC architecture, and consequently removes a very large fraction of instructions used by CISC computers. In earlier stack-based computers, addresses were also provided on the same data stack and intermixed with other types of data. A separated address register dedicated to memory addresses for memory accessing greatly improves the efficiency of data processing on data stack. This design is a significant improvement over prior art stack-based architectures.

(d). Effective use of two stacks removes the need of a large register set in CPU to hold immediate data for processing. A large register set discourages modular and structured programming because of high costs in saving and restoring registers on subroutine calls and returns. This scaleable microprocessor architecture is thus superior to the RISC architecture in effective utilization of registers which are very important resources in a CPU, with the added advantages of encouraging software developers producing modular and structured programs without sacrificing performance.

(e). Effective use of two stacks allows subroutines to be nested without the cumbersome mechanisms of transferring parameter lists among nested subroutines. It also significantly reduces extra work load in saving and restoring contents in registers on subroutine calls and returns. Conventional wisdom against stack-based architecture is that stack computers are slow because operands must be taken from stack for processing, and results must be stored back on stack. These stack operations slow down the computer, because stacks are synthesized and emulated in memory. When stacks are implemented like registers in CPU, accessing stack no longer posts any overhead as data are processed in situ on data stack, and a true stack-based computer can be as fast as register based RISC and CISC computers.

(f). A simple instruction set allows many instructions to be packed in a program word, and thus improves code density and also increase the processing speed of microprocessors. Code packing density is a significantly improved over prior art RISC, CISC and stack-based architectures. Packing many instructions into a program word has additional advantages of matching high instruction execution speed inside CPU with lower memory accessing speed to access memory chips outside CPU in typical microprocessor systems. After one program word is fetched from memory, next program word will not be accessed until all instructions in current program word are executed. For example, in a 32-bit design, instruction execution speed can be 6 times faster than memory accessing speed, because there are 6 instructions packed in a 32-bit program word. The possibility of matching slow memory chips with fast CPU without mediating cache mechanism would significantly reduce component counts, power consumption, and system costs.

(g). A small instruction set also leaves room for hardware designers to add application specific circuitry with application specific instructions to an existing CPU design. It was shown in this patent how to add a serial UART I/O port, a MUL instruction, a DIV instruction, a LOOP instruction, auto-incrementing of address register, and an interrupt controller to this scaleable microprocessor architecture. It is possible to extend the basic design of this scaleable microprocessor architecture towards many different applications, by add new I/O devices, and new instructions to control the new devices.

### DESCRIPTION OF THE PREFERRED EMBODIMENT

(a). A Practcal Instruction Set

This invention of a scaleable microprocessor architecture can be realized in many practical microprocessor designs with different program and data word sizes. Because memory chips are generally available in 8 bit width, the preferred word sizes are multiples of 8 bits. Here we shall present microprocessor designs of 16, 24, 32, and 64 bit words, and demonstrate how a common instruction set can be adapted to these microprocessor designs.

Table 1 shows a practical sample instruction set encoded in 5 bit fields. To the 20 instructions mentioned before, 5 new instructions are added to enhance performance: LOOP, EI, DI, MUL and DIV. There are two types of instructions. The long instructions CALL, BZ, BC, BRA, and LOOP, occupy a 5-bit instruction field and an address field. The rest of the instructions are short instructions, and each occupies one 5-bit field.

TABLE 1
Instruction Set of a Typical Scaleable Microprocessor
Registers:

| | | | |
|---|---|---|---|
| T | Top data register | S | Second data register |
| R | Return register | X | Address register |
| SSTACK | Data stack | RSTACK | Return stack |
| CY | Carry flip-flop | | |

| Code | Mnemonic | Description |
|---|---|---|
| 0 | CALL aaa | Call subroutine at address aaa. |
| 1 | BZ aaa | Branch to address aaa if T=0. |
| 2 | BC aaa | Branch to address aaa if CY=1. |
| 3 | BRA aaa | Branch to address aaa. |
| 4 | LOOP aaa | If R=0, pop RSTACK to R and exit loop. |
| | | If R is not 0, decrement R and loop back to address |
| | | aaa. |
| 5 | RET | Return from subroutine. |
| 6 | EI | Enable interrupt. |
| 7 | DI | Disable interrupt. |
| 8 | | Reserved. |
| 9 | | Reserved. |
| 10 | LDI | Push S on SSTACK, copy T to S, read next program |
| | | word to T. |
| 11 | LD | Push S on SSTACK, copy T to S, read memory word |
| | | to T. Memory address is in X. |
| 12 | | Reserved. |
| 13 | | Reserved. |
| 14 | | Reserved. |
| 15 | ST | Write T to memory, copy S to T, and pop SSTACK to |
| | | S. Memory address is in X. |
| 16 | ADD | Add S to T and pop SSTACK to S. |
| 17 | AND | AND S to T and pop SSTACK to S. |
| 18 | XOR | XOR S to T and pop SSTACK to S. |
| 19 | | Reserved |
| 20 | COM | One's complement of T. |
| 21 | SHR | Shift T right by 1 bit. |
| 22 | MUL | If X(0)=1, add S to T, and shift T-X pair to right by 1 |
| | | bit. |
| | | If X(0)=0, shift T-X pair to right by 1 bit. |
| 23 | DIV | If carry of (T+S) is 1, add S to T and shift T-X pair |
| | | left by 1 bit. |
| | | If carry of (T+S) is 0, shift T-X pair left by 1 bit. |
| | | Either way, fill X(0) with carry. |
| 24 | TS | Push S on SSTACK and copy T to S. |
| 25 | ST | Copy S to T and pop SSTACK to S. |
| 26 | TA | Copy T to X, copy S to T, and pop SSTACK to S. |
| 27 | AT | Push S on SSTACK, copy T to S and copy X to T. |
| 28 | TR | Push R on RSTACK, copy T to R, copy S to T, and |
| | | pop SSTACK to S. |
| 29 | RT | Push S on SSTACK, copy T to S, copy R to T, and |
| | | pop RSTACK to R. |
| 30 | | Reserved |
| 31 | NOP | No operation. |

(b). A 16-Bit Microprocessor Design

In a 16-bit microprocessor, a 16-bit program word contains three short instructions or one long instruction. The instruction fields can be arranged as follows:

Short Instructions:

| | | | |
|---|---|---|---|
| B15-11B10-6 | B5-1 | B0 | |
| Instruction1 | Instruction2 | Instruction3 | Not used |

Long Instructions

B15-11B10-0

Instruction1 Address

Address field in a long instruction is 11 bits wide. If we adopt the page-absolute address model, one can call subroutines and jump to locations inside a 2048 word page. This addressing range is only adequate for small applications. For large applications, branching within 2048 word pages is adequate, but subroutine calls cannot be limited within 2048 word pages. An alternate design is as follows:

Short Instructions:

| B15 | B14-10 | B9-5 | B4-0 |
|---|---|---|---|
| 0 | Instruction1 | Instruction2 | Instruction3 |

Long Instructions

| B15 | B14-10 | B9-0 |
|---|---|---|
| 0 | Instruction1 | Address |

Call Instruction:

| B15 | B14-0 |
|---|---|
| 1 | Address |

Here the range of branching is reduced to a 1024 word page, but the range of subroutine calls is increased to 32768 words, which is large enough for most 16-bit applications.

(c). A 24-Bit Microprocessor Design

In 24-bit microprocessor, a 24-bit program word can contain 4 short instructions or one long instruction. The instruction fields can be arranged as follows:

Short Instructions:

| | | | | |
|---|---|---|---|---|
| B23-19 | B18-14 | B13-9 | B8-4 | B3-0 |
| Insruction1 | Instruction2 | Instruction3 | Instruction4 | Not used |

Long Instructions

| | |
|---|---|
| B23-19 | B18-0 |
| Instruction1 | Address |

Address field in a long instruction is 19 bits wide. The calling/branching range is 512K words, which is large enough for most applications.

(d). A 32-Bit Microprocessor Design

In 32-bit microprocessor, a 32-bit program word can contain 6 short instructions. For long instruction, address field can be reduced so that a few short instructions can be packed in front of a branch instruction. The instruction fields can be arranged as follows:

Short Instructions:

| | | | | | | |
|---|---|---|---|---|---|---|
| B31-27 | B26-22 | B21-17 | B16-12 | B11-7 | B6-2 | B1-0 |
| Instr1 | Instr2 | Instr3 | Instr4 | Instr5 | Instr6 | Resvd |

Long Instructions

| | | | |
|---|---|---|---|
| B31-27 | B26-22 | B21-17 | B16-0 |
| Instr1 | Instr2 | Instr3 | Address |

The address field in a long instruction is reduced to 17 bits. The calling/branching range is 128K words, which is large enough for most applications. However, two extra short instructions can be packed in front of a long instruction, and they improve significantly code packing density in programs.

(e). A 64-Bit Microprocessor Design

In 64-bit microprocessor, a 64-bit program word can contain 12 short instructions. The design of long instructions is very similar to that in above 32-bit design. A 15 bit address field is generally adequate. The calling/branching range is 32K words, which is large enough for most applications. However, up to 8 short instructions can be packed in front of a long instruction.

Short Instructions:

| | | | | | | | | | | | | |
|---|---|---|---|---|---|---|---|---|---|---|---|---|
| B63 | B58 | B53 | B48 | B43 | B38 | B33 | B28 | B23 | B18 | B13 | B8 | B3-0 |
| Instr1 | Instr2 | Instr3 | Instr4 | Instr5 | Instr6 | Instr7 | Instr8 | Instr8 | Instr10 | Instr11 | Instr12 | Resvd |

Long Instructions

| | | | | | | | | | |
|---|---|---|---|---|---|---|---|---|---|
| B63 | B58 | B53 | B48 | B43 | B38 | B33 | B28 | B23 | B18-0 |
| Instr1 | Instr2 | Instr3 | Instr4 | Instr5 | Instr6 | Instr7 | Instr8 | Instr8 | Address |

The address field in a long instruction is set to 19 bits. The calling/branching range is 512K words, which is large enough for very substantial applications. 7 additional short instructions can be packed in front of a long instruction.

An alternative method to implement a 64-bit microprocessor is to use the same instruction format as the 32-bit microprocessor mentioned above, using 32-bit instructions. This approach will significantly improve coding density, because the extra instruction slots before a branching instruction can be utilized more efficiently.

Conclusion, Ramification, and Scope

Accordingly, it is apparent that this scaleable microprocessor architecture embodied the following significant improvements on designs of microprocessors over prior art CISC, RISC and stack-based architectures:

(a). Architectural simplicity leads to smaller, faster, less power-consuming, and cheaper microprocessors.

(b). A small instruction set allows a family of microprocessors to be manufactured with program word size scaleable from 15 bits up, including but not limited to 16, 24, 32 and 64 bits, to suit appropriate applications.

(c). A dedicated address register simplifies microprocessor architecture by eliminating various addressing modes and a large fraction of instructions employing these addressing modes.

(d). Effective use of two stacks eliminates the large registers set required by CISC and RISC architectures.

(e). Effective use of two stacks allows convenient subroutine nesting and thus encourages modular and structured programming practices.

(f). A small instruction set allows matching of a fast CPU with slower memory chips to reduce system costs.

(g). A small instruction set leaves room for hardware designers to expand the architecture to suit specific applications.

Although the description above contains many specificities, these should not be construed as limiting the scope of the invention but as merely providing illustrations of some of the presently preferred embodiments of this invention. For examples, the exact prescriptions of individual instructions can be modified, the assignments of code to instructions can be re-arranged, the length of address field can be adjusted, and the current instruction set and be extended.

Thus the scope of the invention should be determined by the appended claims and their legal equivalents, rather by the examples given.

What is claimed is:

1. A scaleable microprocessor architecture based on a simple, efficient and orthogonal instruction set comprising of but not limited to following instructions, BRA, BZ, BC, CALL, RET, LD, LDI, ST, ADD, AND, XOR, COM, SHR, TA, TS, TR, AT, ST, RT and NOP, and in which a plurality of such instructions can be encoded in program words scaleable from 15 bits up, including but not limited to 16, 24, 32, and 64 bits.

2. A microprocessor based on said scaleable microprocessor architecture of claim 1, comprising of a central processing unit, a memory device, a bus system to connect the said central processing unit to said memory device, means connected to said bus for fetching program words and data words from said memory device to said central processing unit, said program words having a width scaleable from 15 bits up, including but not limited to 16, 24, 32, and 64 bits, said program word containing a plurality of instructions which are executed in sequence paced by a single phase master clock at a rate of one instruction per clock cycle.

3. The memory device of claim 2 comprising of, but not limited to, read-only memory ROM, random access memory RAM, dynamic random access memory DRAM, flash programmable read only memory, and combinations thereof.

4. The central processing unit of claim 2, comprising of a plurality of registers, a plurality of logic circuits, a plurality of multiplexers, means connection said registers to said logic circuits, means connecting said logic circuits to said multiplexers, means connecting said multiplexers to said registers, means to clear said registers by an external reset signal, means to latch new data into said registers from outputs of said multiplexers on the rising edge of an external master clock, and a majority of said registers, logic circuits, and multiplexers being organized in four major processing units: a data processing unit, an address processing unit, a program sequencing unit, and an address storage unit.

5. The data processing unit of claim 4 comprising of a top data register, a second data register, a plurality of registers organized as a Last-in-First-out (LIFO) data stack, a top data multiplexer, a second data multiplexer, and an arithmetic logic unit, said data processing unit supporting a push operation where contents in said second data register are pushed on said data stack and contents in said top data register are copied into said second data register and contents in said top data register are replaced by results from the said arithmetic logic unit or from registers in other processing units, and said data processing unit in addition also supporting a pop operation where contents in said second data register are copied into said top data register and a top item on said data stack is popped into said second data register,

6. The arithmetic logic unit of claim 5 comprising of an adder adding contents from said top data register and said second data register, a plurality of AND gates producing bit-wise AND signals from said top data register and said second data register, a plurality of exclusive OR gates producing bit-wise XOR signals from said top data register and said second data register, a plurality of inverting gates producing one's complement signals from said top data register, a top right shifter shifting contents of said top data register to the right by 1 bit.

7. The top data multiplexer of claim 5 selecting one of a plurality of outputs from following sources to be latched into said top data register: said adder in said arithmetic logic unit, said AND gates in said arithmetic logic unit, said exclusive OR gates in said arithmetic logic unit, said inverting gates in said arithmetic logic unit, said top right shifter in said arithmetic logic unit, said second data register, said data bus from said memory device, and registers in said address processing unit, said program sequencing unit, and said address storages unit..

8. The second data multiplexer of claim 5 selecting one of a plurality of outputs from the following sources to be latched into said second data register: said top data register, and said data stack.

9. The address processing unit of claim 4 comprising of a program address register, a data address register, a program address multiplexer, and an memory address multiplexer, said program address register holding an address of next program word to be fetched from said memory device, said data address register holding an address of memory location from which a data word is read and to which a data word is written, said program address multiplexer selecting an address from a plurality of sources to be latched into said program address register on the rising edge of said master clock when said program address register is enabled, said memory address multiplexer selecting an address in said program address register to be placed on said address bus when reading program words from said memory device, said memory address multiplexer selecting an address in said data address register to be placed on said address bus when reading data words from said memory device or writing data to said memory device, said data address register latching data from said top data register on the rising edge of said master clock when loading data address register is enabled.

10. The program address multiplexer of claim 9 selecting one of a plurality of outputs from the following sources to be routed to said program address register: said program address incrementer to fetch next program word from said memory device, a program address adder which supplies a calling/branching address, a plurality of interrupt input pins for an interrupt vector to branch to an interrupt service routine, and a return address register in said address storage unit to return to program location interrupted by an interrupt service routine or by a subroutine call instruction.

11. The address processing unit of claim 9 additionally comprising of a data address multiplexer selecting data from two sources to be routed to said data address register: said top data register and a data address incrementer which allows an address in said data address register to be auto-incremented when executing an optional auto-incrementing memory read/write instruction.

12. The address storage unit of claim 4 comprising of a return address register, and a plurality of registers organized as a second Last-In-First-Out (LIFO) return stack, and a return address multiplexer, said address storage unit supporting a push operation where contents in said return address register are pushed on said return stack and contents in said return address register are replaced by outputs from said return address multiplexer, said address storage unit in addition also supporting a pop operation where said return stack is popped into said return address register, said return address register generally containing a return address saved from said program address register when a subroutine call instruction is executed, said return address multiplexers selecting one of a plurality of sources and routing selected data to be latched into said return address register on the rising edge of said master clock when loading said return address register is enabled.

13. The return address multiplexer of claim 12 selecting one output from the following sources: said program address register, and said top data register.

14. The return address multiplexer of claim 13 additionally selecting a source from an return address decrementer which decrements contents in said return address register, said return address decrementer allowed an optional loop instruction to be added to said instruction set, said loop instruction decrementing a loop count in said return address register and causing a branch address to be loaded into the program address register if said loop count in said return address register is not zero, said loop instruction exiting the loop if said loop count in said return address register is zero.

15. The program sequencing unit of claim 4 comprising an instruction counter register, an instruction latch register, an instruction multiplexer, and an instruction decoder, said instruction counter register being cleared when the last instruction in a program word is executed or else incremented on the rising edge of said master clock, said instruction latch register being loaded with a new program word from said data bus of said memory device when loading said instruction counter register is enabled, said instruction multiplexer beino controlled by a count in said instruction counter register sequentially selecting one of the instructions in said instruction latch register to be sent to said instruction decoder, said instruction decoder producing selecting signals to all multiplexers in said central processing unit, and said instruction decoder also producing enable signals to all registers and stacks in said central processing unit.

16. The central processing unit of claim 4 additionally comprising an output flip-flop device which latches the least significant bit of said top data register when an arithmetic right shift instruction is executed, said output flip-flop device sending its output to an output pin, said output flip-flop device being used as a serial output port for said microprocessor to send data to an external terminal device.

17. The central processing unit of claim 4 additionally comprising an input flip-flop device which latches the carry bit of said adder in said arithmetic logic unit when an addition instruction is executed or latches the state of an input pin when an arithmetic right shift instruction is executed, said input flip-flop device causing conditional branching when a branch on carry instruction is executed, said input flip-flop device being used as a serial input port to receive data from an external terminal device.

18. The central processing unit of claim 4 additionally comprising a double word right shifter, the most significant half of said double word right shifter receiving contents of said top data register if the least significant bit in said data address register is cleared or receiving output of said adder if the least significant bit in said data address register is set, the least significant half of said double word right shifter receiving contents of said data address register, contents in said double word right shifter being shifted to the right by 1 bit and said carry bit from said adder being copied into the most significant bit of said double word right shifter, results in the most significant half of said double word right shifter latched into said top data register on the rising edge of said master clock if a multiplication step instruction is executed, results in the least significant half of said double word right shifter latched into said data address register on the rising edge of said master clock if a multiplication step instruction is executed.

19. The central processing unit of claim 4 additionally comprising a double word left shifter, the most significant half of said double word left shifter receiving contents of said top data register if said carry bit from said adder is cleared or receiving output of said adder if said carry bit from said adder is set, the least significant half of said double word left shifter receiving contents of said data address register, contents in said double word left shifter being shifted to the left by 1 bit and said carry bit being copied into the least significant bit of said double word left shifter, results of the most significant half of said double word left shifter latched into said top data register on the rising edge of said master clock if a division step instruction is executed, and results of the least significant half of said double word left shifter latched into said data address register on the rising edge of said master clock if a division step instruction is executed.

20. The central processing unit of claim 4 additionally comprising an interrupt handling means which causes said central processing unit to call an interrupt service routine when interrupt is enabled, at least one of input interrupt pins is asserted, and said central processing unit is fetching a program word from said memory, and said interrupt services routine being selected from an interrupt vector table by a bit pattern read in from said input interrupt pins.
